(19) United States
(12) Patent Application Publication
(10) Pub. No.: US 2018/0322480 A1
(43) Pub. Date: Nov. 8, 2018

(54) CREDIT TRANSFER VIA NETWORKED MOBILE COMPUTING DEVICES

(71) Applicant: Promociones Bursatiles S.A., Panama City, PA (US)

(72) Inventor: Roberto Arturo Solis Monsanto, Doral, FL (US)

(21) Appl. No.: 15/587,377

(22) Filed: May 4, 2017

(51) Int. Cl. G06Q 20/10; G06Q 20/40; G06F 17/30

(52) U.S. Cl. CPC G06Q 20/108; G06F 17/30864; G06Q 20/401

(57) ABSTRACT

A method and system for facilitating transfer of credit over a communications network is disclosed. The method on a web server includes storing in an attached database a record for a sending user and for a receiving user, receiving credit confirmation from a payment gateway for the sending user, increasing the credit balance of the sending user in the record, receiving a command to transfer a credit amount, and a unique identifier for the receiving user, determining that the second credit amount is less than the credit balance of the sending user, decreasing the credit balance of the sending user, increasing the credit balance of the receiving user, and transmitting a credit increase confirmation to a mobile device of the receiving user, wherein the credit increase confirmation includes the credit balance of the receiving user.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNOLOGICAL FIELD

The disclosed embodiments relate to the field of electronic commerce and, more specifically, the disclosed embodiments relate to the field of credit transfers using mobile computing devices.

### BACKGROUND

The banking industry has been one of the major motivators for progress in modern society. The banking industry provides much needed capital for large and small businesses and provides a sound backdrop for the finances of individuals and corporations. The increased safety of the industry and the ubiquity of the Internet has brought banking to the masses. It is estimated that more than half of all adult individuals participate in the banking industry worldwide.

One of the aspects of banking that has not enjoyed much innovation is remittances. A remittance is a transfer of money by a foreign worker to an individual in his or her home country. Remittances are one of the largest financial inflows to developing countries. Today, more than $400 billion went to developing countries in remittances, while overall global remittances total more than $600 billion. The typical process for sending a remittance abroad is as follows. A sending user visits a point of sale location, such as a Western Union location oat a grocery store, and provides cash, as well the identity of the receiving user. The point of sale location then transmits data pertaining to said transaction to a point of sale location near the receiving user. The receiving user then visits the point of sale location, confirms his identity, and subsequently receives the cash at the point of sale location.

One of the drawbacks associated with the conventional way of processing a remittance is the tedious and time consuming task of having both the sending user and the receiving user visit a point of sale location. Another drawback associated with conventional remittances involves the identifying the receiving user. If an incorrect or incomplete name or identifying number is provided for the receiving user, this can cause problems for both the sending user and the receiving user, who may be required to make another visit to the point of sale location. This is also tedious and time consuming. Yet another problem with the conventional process of remittances involves the legal rules and regulations that must be considered. International transfers of money involve a myriad of state, federal, international and regional rules and regulations that must be navigated in order to make sure that said transactions are compliant. This adds an administrative process to the process of remittances, which increases the cost of sending said remittances.

Therefore, what is needed is a system and method for improving the problems with the prior art, and more particularly for a more efficient method and system for facilitating the transfer of credit between users.

### SUMMARY

A method and system for facilitating transfer of credit over a communications network is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a method on a web server for facilitating transfer of credit over a communications network is disclosed. The method on a web server for facilitating transfer of credit over a communications network includes storing in an attached database a record for a sending user and for a receiving user, wherein each record includes a unique identifier, and a credit balance; receiving, via the communications network, credit confirmation from a payment gateway, wherein the credit confirmation includes the unique identifier for the sending user, and a first credit amount; increasing the credit balance of the sending user in the record of the sending user to reflect the first credit amount of the credit confirmation; receiving from a mobile device of the sending user, via the communications network, a command to transfer a second credit amount, and a unique identifier for the receiving user, wherein the command to transfer and the unique identifier are entered by the sending user into a graphical user interface in the mobile device of the sending user; determining that the second credit amount is less than the credit balance of the sending user in the record of the sending user; and decreasing the credit balance of the sending user in the record of the sending user by the second credit amount, and increasing the credit balance of the receiving user in the record of the receiving user by the second credit amount; and transmitting, via the communications network, a credit increase confirmation to a mobile device of the receiving user, wherein the credit increase confirmation includes the credit balance of the receiving user in the record of the receiving user.

Additional aspects of the claimed embodiments will be set forth in part in the description which follows, and in part will be obvious from the description, or may be learned by practice of the claimed embodiments. The aspects of the claimed embodiments will be realized and attained by means of the elements and combinations particularly pointed out in the appended claims. It is to be understood that both the foregoing general description and the following detailed description are exemplary and explanatory only and are not restrictive of the claimed embodiments, as claimed.

### BRIEF DESCRIPTION OF THE SEVERAL VIEWS OF THE DRAWINGS

The accompanying drawings, which are incorporated in and constitute part of this specification, illustrate embodiments of the claimed subject matter and together with the description, serve to explain the principles of the disclosed embodiments. The embodiments illustrated herein are presently preferred, it being understood, however, that the claimed subject matter is not limited to the precise arrangements and instrumentalities shown, wherein:

FIG. 1 is a block diagram illustrating the network architecture of a system for facilitating transfer of credit over a communications network, in accordance with one embodiment.

FIG. 2A is a block diagram showing the data flow when transferring credit over a communications network using the claimed system, according to one embodiment.

FIG. 2B is a block diagram showing the data flow pertaining to redeeming of credit using the system for transfer of credit over a communications network, according to one embodiment.

FIG. 3A is a flow chart depicting the general control flow of a process for facilitating transfer of credit over a communications network, according to one embodiment.

FIG. 3B is a diagram depicting the data flow between the main players of the process for facilitating transfer of credit over a communications network, according to one embodiment.

FIG. 4 is a block diagram of a system including an example computing device and other computing devices.

### DETAILED DESCRIPTION

The following detailed description refers to the accompanying drawings. Wherever possible, the same reference numbers are used in the drawings and the following description to refer to the same or similar elements. While embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed embodiments. Instead, the proper scope of the claimed subject matter is defined by the appended claims.

The disclosed embodiments improve upon the problems with the prior art by providing a system that allows a sending user to quickly and seamlessly send a transfer of credit to a receiving user, using only his or her mobile computing device. Once the transfer of credit is effectuated, the receiving user may use the credit in any participating point of sale location. Therefore, the disclosed embodiments reduce or eliminate the need for the sending user or receiving user to be present at any point of sale location in order to effectuate a transfer of credit. This is advantageous for both the sending and receiving users, as it provides greater flexibility in the process of sending credit and allows for a greater volume of credit to be sent. An additional benefit of the disclosed embodiments is the automatic confirmation of the identity of the receiving user, which reduces or eliminates the problems encountered by users of the conventional remittance process. Lastly, the disclosed embodiments provide a credit transfer method and system that need not comply with any rules or regulations pertaining to the transfer of money or funds, because the disclosed embodiment apply solely to the transfer of credit that may be used at participating point of sale locations, rather than the transfer of money or funds.

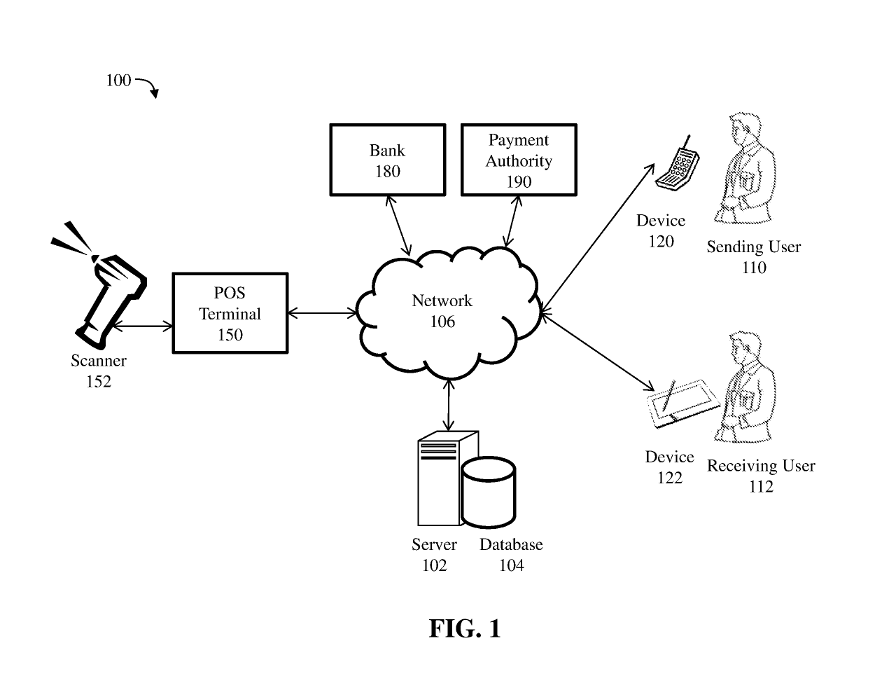

Referring now to the drawing figures in which like reference designators refer to like elements, there is shown in FIG. 1 an illustration of a block diagram showing the network architecture of a system 100 and method for facilitating transfer of credit over a communications network in accordance with one embodiment. A prominent element of FIG. 1 is the server 102 associated with repository or database 104 and further coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Server 102 is a central controller or operator for functionality of the disclosed embodiments, namely, the transfer of credit between users.

FIG. 1 includes mobile computing devices 120 and 122, which may be smart phones, mobile phones, mobile computers, tablet computers, handheld computers, laptops, or the like. Mobile computing devices 120 and 122 correspond to a sending user 110 and a friend or receiving user 112 of the user 110. FIG. 1 further shows that server 102 includes a database or repository 104, which may be a relational database comprising a Structured Query Language (SQL) database stored in a SQL server. Devices 120, 122 and 150 may also each include their own database. The repository 104 serves data from a database, which is a repository for data used by server 102 and devices 120, 122, 150 during the course of operation of the disclosed embodiments. Database 104 may be distributed over one or more nodes or locations that are connected via network 106.

The database 104 may include a user record for each user 110 or 112. A user record may include: contact/identifying information for the user (name, address, telephone number(s), email address, etc.), an IP address for a mobile computing device of the user, information pertaining to transfers of credit by the user, contact/identifying information for friends or receiving users of the user, electronic payment information for the user, information pertaining to transfers of credit received by the user, etc. A user record may also include bank account data, password data and wire transfer data. A user record may also include a unique identifier for each user, a residential address for each user, the current location of each user (based on location-based services from the user's mobile computer), transaction data for previous transfers of credit, and a description of past electronic transfers of credit. A user record may further include demographic data for each user, such as age, sex, income data, race, color, marital status, etc. A user record may include a credit amount, which is an amount of credit that is currently attributed to the user. This amount is akin to the amount of money a user has in his bank account. A user record may also include credentials, such as a login name, user name, password, biometric password, responses to questions, etc. The credentials are used to authenticate a user when said user logs in to the system, sends commands to the system or otherwise interacts with the system.

Transaction data may include one or more unique identifiers for the transaction itself, unique identifiers for the parties or users involved, one or more credit or monetary transfer amounts, sender and receiver contact/identifying information, time and date information, and electronic payment information. In one embodiment, electronic payment information may comprise user contact/identifying information and any data garnered from a purchase card (i.e., purchase card data), as well as any authentication information that accompanies the purchase card. Purchase card data may comprise any data garnered from a purchase card and any authentication information that accompanies the purchase card. In one embodiment, electronic payment information may comprise user login data, such as a login name and password, or authentication information, which is used to access an account that is used to make a payment.

FIG. 1 shows an embodiment wherein networked computing devices 120, 122 interact with server 102 and repository 104 (as well as entities 150, 180 and 190) over the network 106. Server 102 includes a software engine that delivers applications, data, program code and other information to networked computing devices 120, 122 (as well as entities 150, 180 and 190). It should be noted that although FIG. 1 shows only the networked computers 102, 120, 122, 150, 180 and 190, the system of the disclosed embodiments supports any number of networked computing devices connected via network 106. Further, server 102, entities 150, 180 and 190, and devices 120, 122 include program logic such as computer programs, mobile applications, executable files or computer instructions (including computer source code, scripting language code or interpreted language code that may be compiled to produce an executable file or that may be interpreted at run-time) that perform various functions of the disclosed embodiments.

Note that although server 102 is shown as a single and independent entity, in one embodiment, the functions of server 102 may be integrated with another entity, such as one of the devices 120, 122, point of sale 150, payment authority 190 or bank 180. Further, server 102 and its functionality, according to a preferred embodiment, can be realized in a centralized fashion in one computer system or in a distributed fashion wherein different elements are spread across several interconnected computer systems.

FIG. 1 also shows a payment authority 190, which acts to effectuate payments by users 110 or 112 for credit transfers, or the like. In the course of a credit transfer transaction, server 102 may interface with payment authority 190 to effectuate payment by a user. In one embodiment, the payment authority 190 is a payment gateway, which is an e-commerce Application Service Provider (ASP) service that authorizes and processes payments from one party to another. The payment authority 190 may accept payment via the use of purchase cards, i.e., credit cards, charge cards, bank cards, gift cards, account cards, etc. FIG. 1 further shows bank 180, which may be a third party banking entity that provides a web based automated clearinghouse service. An Automated Clearing House (ACH) is an electronic network for financial transactions in the United States. ACH processes large volumes of credit and debit transactions in batches. ACH is a computer-based clearing and settlement facility established to process the exchange of electronic transactions between participating depository institutions..

FIG. 1 also shows a POS or Point of Sale terminal 150, which represents a local place for transacting business, such as a grocery store, convenience store, big box store, restaurant, bar, pub, sports complex, bank, etc. Scanner 152 is shown as part of the POS terminal 150. Scanner 152 may be an infrared scanner, a bar code scanner, an image scanner, barcode reader, biometric scanner, RFID scanner, NFC scanner, etc.

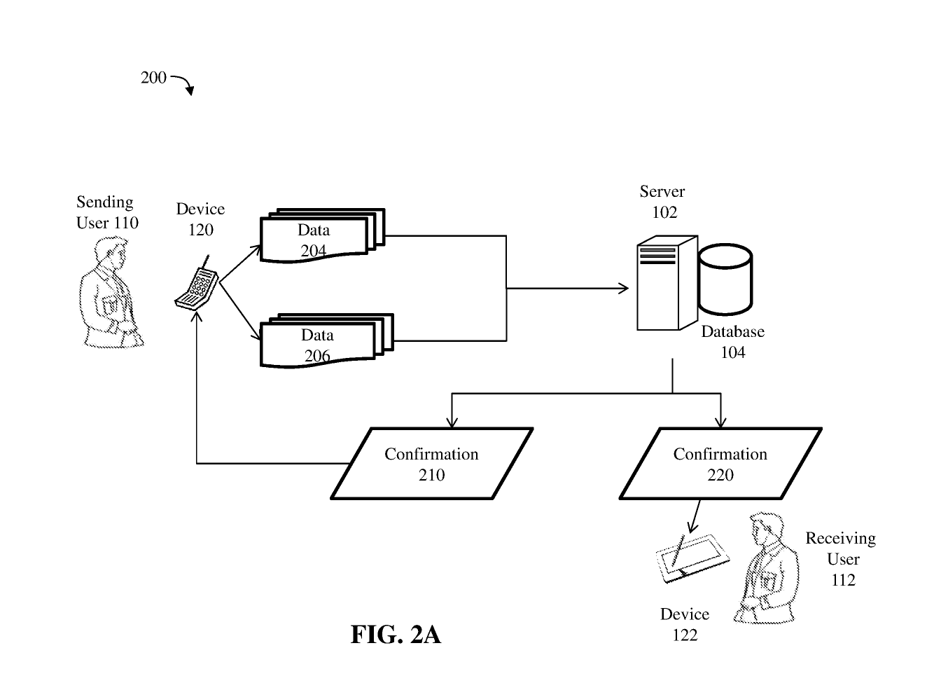

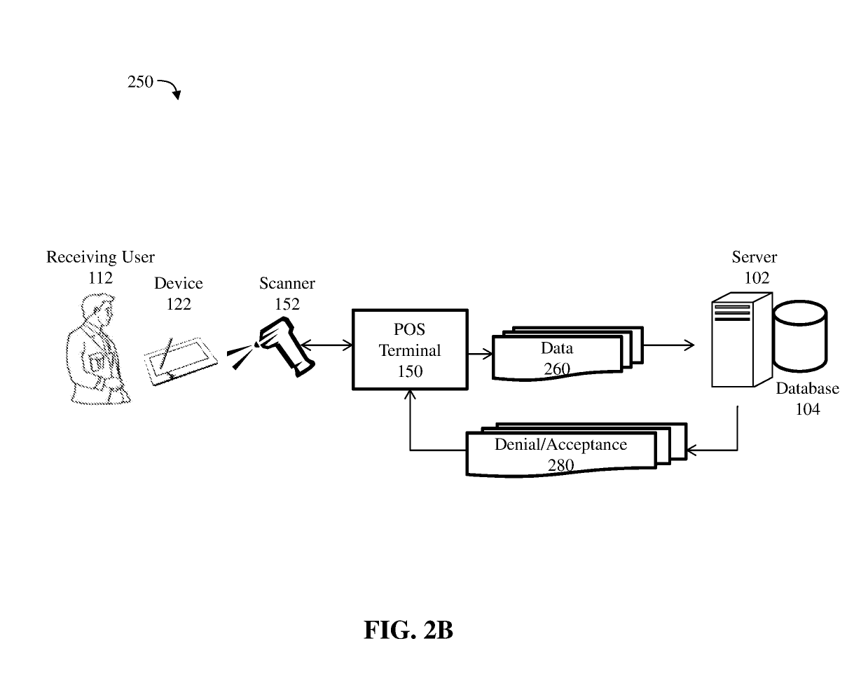

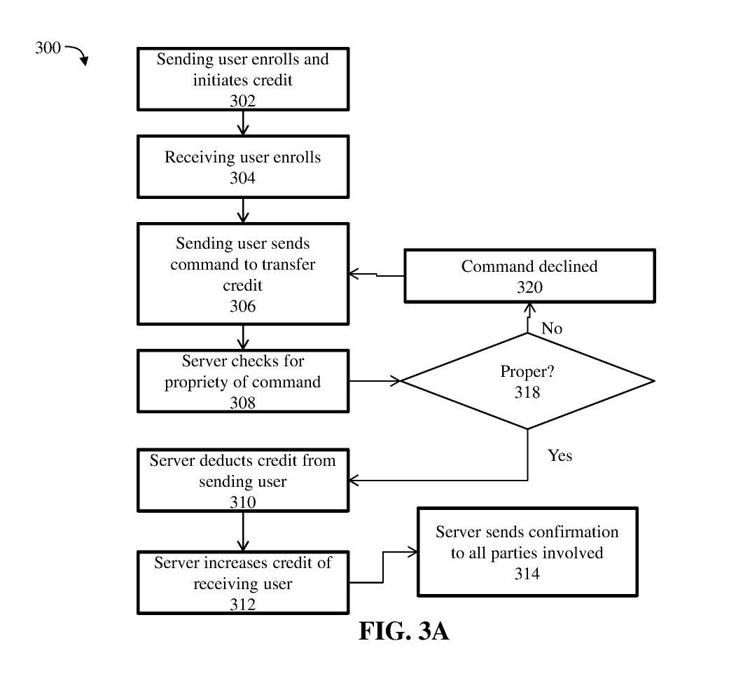

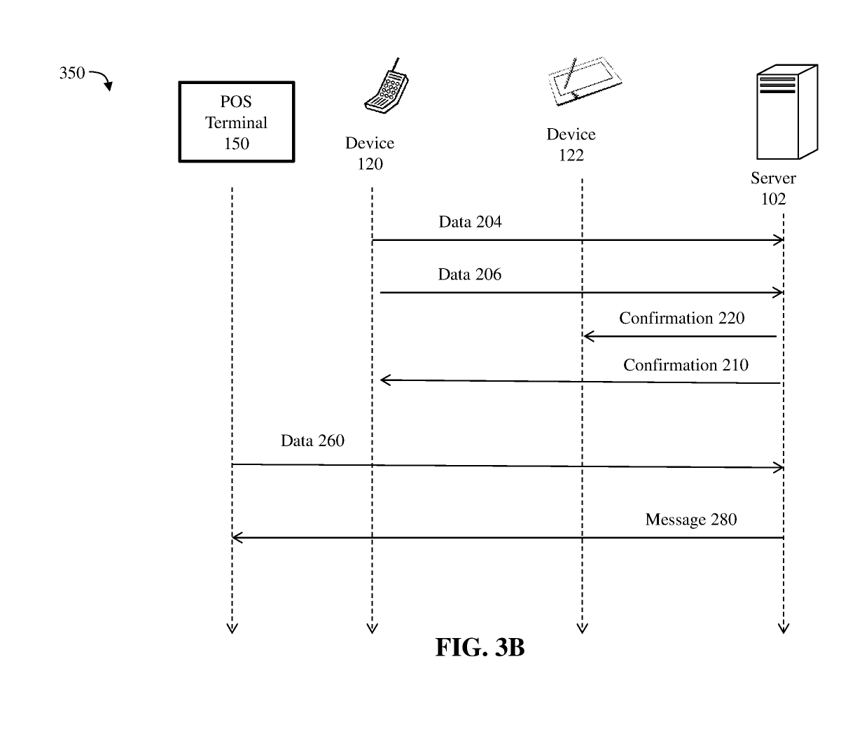

The process of transferring credit between users will now be described with reference to FIGS. 2A through 3B below. FIGS. 2A through 3B depict the data flow and control flow in the process for facilitating a transfer of credit over a communications network 106, according to one embodiment. The process of the disclosed embodiments begins with step 302 (see flowchart 300), wherein the user 110 may enroll or register with server 102, bank 180 and/or POS terminal 150. In the course of enrolling or registering, user 110 may enter data into his device 120 by manually entering data into a mobile application via keypad, touchpad, or via voice. In the course of enrolling or registering, the user 110 may enter any data that may be stored in a user record, as defined above. Also in the course of enrolling or registering, the server 102, bank 180 and/or POS 150 may generate a user record for each registering user and store the user record in an attached database, such as database 104.

Also in step 302, the user 110 may generate a credit on his account by submitting cash to the POS 150 (wherein the POS 150 submits a confirmation of payment to the server 102), charging a payment card using electronic payment information he submitted (wherein the payment authority 190 submits a confirmation of payment to the server 102), or using credit that was transferred to the user 110 using the disclosed embodiments. Specifically, user 110 may enter electronic payment information (i.e., data 204) into his device 120 by manually entering data into a mobile application via keypad, touchpad, or via voice (see diagram 200). User 110 may alternatively enter data 204 into his device 120 by using Radio Frequency Identification (RFID), or Near Field Communication (NFC). RFID is the use of a wireless non-contact system that uses radio-frequency electromagnetic fields to transfer data from one node to another. NFC is a set of standards for smart-phones and similar devices to establish radio communication by bringing nodes into close proximity.

Alternatively, user 110 may also enter data 204, or a portion thereof, into his device 120 by swiping a purchase card through a card reader communicatively coupled with the device 120 (or located at a POS). A card reader is a data input device that reads data from a card-shaped storage medium. One example of a card reader is a magnetic card reader, which reads magnetic stripe cards, such as credit cards. A mobile card reader is a card reader that is communicatively coupled with a mobile computing device. In one embodiment, upon reading any purchase card data, the device 120 immediately encrypts the purchase card data that was read, so as to produce encrypted purchase card data. In this embodiment, the encrypted purchase card data is transmitted to the server 102 in data 204.

Also in step 302, the data 204, or a portion thereof, may be transmitted to payment authority 190 for processing. The payment authority 190 processes the electronic payment information of the user 110 and verifies whether payment has been effectuated. If so, the payment authority 190 may send a verification message to the server 102 thereby verifying that the payment has been effectuated. The data 204 may be stored in association with the user record for user 110.

In one embodiment, the result of step 302 is that the credit balance of the user 110, as reflected in the user record of user 110, is updated to include the addition of the valued added to the credit balance, as described above. Once step 302 is completed, the server 102 may transmit, via the communications network 106, a message to the mobile device of the sending user 110 indicating that the credit balance of the sending user has been modified to reflect the addition of the value added by the user 110.

Next, in step 304, the receiving user 112 also enrolls, similarly to the process by which user 110 enrolls. Then, in step 306, the user 110 decides to transfer credit to his friend, such as receiving user 112. In step 306, the user 110 may enter data 206 identifying his friend 112 (such as a unique name, a unique identifier, a telephone number, email address, social network sign-in, contact information, etc.) into his device 120 by manually entering data into a mobile application via keypad, touchpad, or via voice. In step 306, the user 110 also identifies in data 206 how much credit he would like to transfer to his friend 112, which is referred to as the transfer amount. Data 206 may also include any data in the user record of either user 110 or user 112, such as a unique identifier for user 110.

In one embodiment, prior to the execution of any of steps 302, 304, and 306, the performing user must authenticate himself or herself using his or her device, by entering or otherwise providing credentials. This may include having the performing user enter his or her credentials via the user's mobile device, or otherwise inputting credentialed information, such as biometric information. The server 102 then checks said credentials against credentials stored in the performing user's user record in the attached database. If said credentials match, then the user is authenticated or authorized to access his or her account, such as sending credit transfers.

In step 308, the server 102 receives data 206 and accesses the sending user's record in the database 104 corresponding to determine whether there is enough credit (i.e., the credit amount) in the user's account to effectuate the transfer of the transfer amount to the receiving user. The server 102 makes said determination in step 318. If the result of said determination is positive, then control flows to step 310. Otherwise, control flows to step 320. In step 320, the transaction is denied and control flows back to step 306. In step 310, the server 102 deducts the transfer amount from the credit amount in the user record of the sending user 110, and in step 312, the server 102 increases the credit amount in the user record of the receiving user by the transfer amount.

In step 314, the server 102 transmits confirmation 210 to the device 120 of user 110 and confirmation 220 to the device 122 of the friend 112, wherein said confirmations confirm the transfer of credit. In one embodiment, in step 314, the server 102 may transmit the confirmations as follows: 1) via a network protocol, such as HTTP, to the IP address of the mobile device of the user, as the IP address is stored in the transaction record(s) associated with the transfer or the user record of the user, or in response to an HTTP request from the mobile device of the user (wherein the HTTP request includes the IP address of the user's device), or 2) via text message to the telephone number of the mobile device of the user, as the telephone number is stored in the transaction record(s) associated with the transfer or the user record, or in response to a text message from the mobile device of the user (wherein the text message includes the telephone number of the device of the user).

Once step 314 is completed, the server 102 may transmit, via the communications network 106, a message to the mobile device of the sending user 110 indicating that the credit balance of the sending user has been modified to reflect the deduction of the value transferred by the user 110.

FIG. 2B shows that the user 112 may visit a POS location 150 to purchase a product or service using the credit amount he received from the user 110. User 112 may present the credit (displayed on his device 122, for example) for scanning by a scanner 152 at the POS location 150. In this step, the scanner 152 may read data 260 from the device 122, which is transmitted from the POS location 150 to the server 102 (see diagram 250). The data 260 may be any data displayed in the device 122, such as a unique identifier, a QR code, etc. The server 102 receives data 260 and accesses the user record for user 112 in the database 104 corresponding to the data 260 (such as the unique identifier). The server 102 then determines whether the user 112 has enough credit to effectuate the purchase. Specifically, the server 102 opens the user record for user 112 and checks his credit amount. If the user 112 has enough credit, then an acceptance message 280 is sent by server 102 to the POS terminal 150. In this case, the credit amount of the user 112 is lowered by the amount of the sale. Otherwise a denial message 280 is sent by server 102 to the POS terminal 150 and the sale is denied. Alternatively, the user 112 may present his credit at the POS terminal 150 using NFC.

In one embodiment, any of the data sent to or from the devices 120, 122, or nodes 150, 180, 190, 102, may be encrypted. This includes data 204, 206, 210, 220, 260, 280. In this embodiment, said encrypted data is then decrypted by the receiving node, assuming the correct user has logged into said node and authenticated himself or herself.

In one embodiment, the credit transferred to the receiving user is considered solely a credit that can be used at one or more specified POS locations to purchase goods or services. In this embodiment, the credit transferred is not considered cash, money or legal tender, but rather is considered a credit that can be used to purchase goods and services only at certain specified locations. In one alternative, only certain specified amounts of credit may be used at one time, and only certain goods and services may be purchased using said credit. This characterization of the value received by the receiving user, and how said value can be used, reduces or eliminates the problems with the prior art described above, namely, the myriad of regulations and laws that must be followed when transferring money, especially international remittances. Thus, the claimed subject matter may be used to transfer credit that accomplishes many of the same goals as regular money or cash, without having to comply with the onerous regulations and laws that apply to regular money or cash.

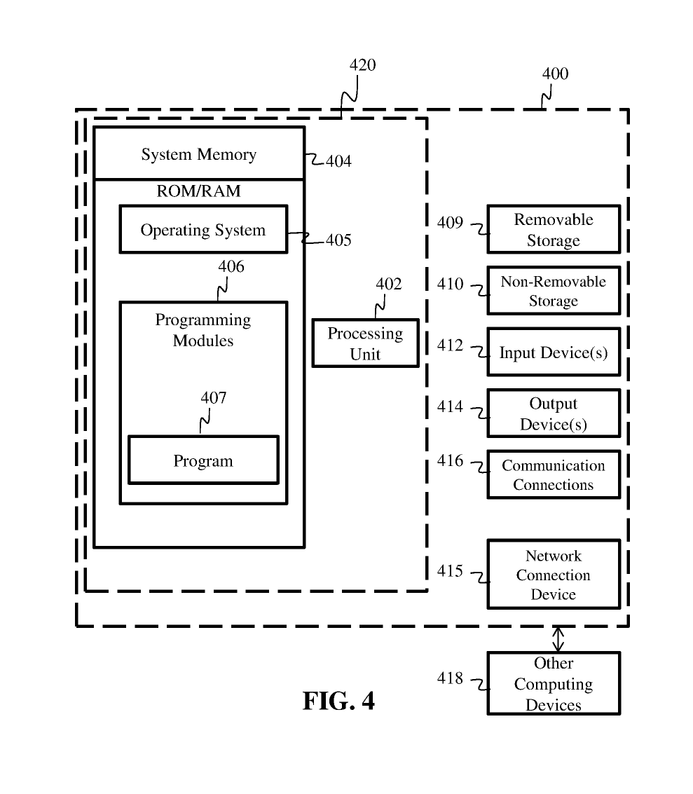

FIG. 4 is a block diagram of a system including an example computing device 400 and other computing devices. Consistent with the embodiments described herein, the aforementioned actions performed by 102, 120, 122, and 150 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for the methods shown in FIGS. 2A-3B above.

With reference to FIG. 4, a system consistent with an embodiment herein may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination or memory. System memory 404 may include operating system 405, one or more programming modules 406 (such as program module 407). Operating system 405, for example, may be suitable for controlling computing device 400's operation. In one embodiment, programming modules 406 may include, for example, a program module 407. Furthermore, embodiments herein may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included.

The aforementioned devices are only examples, and other devices may be added or substituted.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

Computing device 400 may also contain a network connection device 415 that may allow device 400 to communicate with other computing devices 418, such as over a network in a distributed computing environment, for example, an intranet or the Internet. Device 415 may be a wired or wireless network interface controller, a network interface card, a network interface device, a network adapter or a LAN adapter. Device 415 allows for a communication connection 416 for communicating with other computing devices 418. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 may perform processes including, for example, one or more of the methods shown in FIGS. 2A-3B above. The aforementioned processes are examples, and processing unit 402 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with the embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general purpose computer or in any other circuits or systems.

Embodiments herein, for example, are described above with reference to block diagrams and/or operational illustrations of methods, systems, and computer program products. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments herein have been described, other embodiments may exist. Furthermore, although embodiments have been described as being associated with data stored in 1memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the claimed embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method on a web server for facilitating transfer of credit over a communications network, comprising:
storing in an attached database a record for a sending user and for a receiving user, wherein each record includes a unique identifier, and a credit balance;
receiving, via the communications network, credit confirmation from a payment gateway, wherein the credit confirmation includes the unique identifier for the sending user, and a first credit amount;
increasing the credit balance of the sending user in the record of the sending user to reflect the first credit amount of the credit confirmation;
receiving from a mobile device of the sending user, via the communications network, a command to transfer a second credit amount, and a unique identifier for the receiving user, wherein the command to transfer and the unique identifier are entered by the sending user into a graphical user interface in the mobile device of the sending user;
determining that the second credit amount is less than the credit balance of the sending user in the record of the sending user;
decreasing the credit balance of the sending user in the record of the sending user by the second credit amount, and increasing the credit balance of the receiving user in the record of the receiving user by the second credit amount; and
transmitting, via the communications network, a credit increase confirmation to a mobile device of the receiving user, wherein the credit increase confirmation includes the credit balance of the receiving user in the record of the receiving user.

2. The method of claim 1, wherein each record further includes credentials for a user.

3. The method of claim 2, wherein the credit confirmation is encrypted and wherein the credit confirmation also includes a time stamp.

4. The method of claim 3, wherein the step of increasing the credit balance of the sending user further comprises transmitting, via the communications network, a message to the mobile device of the sending user indicating that the credit balance of the sending user has been modified to reflect the addition of the first credit amount.

5. The method of claim 4, wherein the step of receiving from the mobile device of the sending user further includes receiving credentials from the mobile device of the sending user, via the communications network, wherein the credentials are entered by the sending user into the graphical user interface in the mobile device of the sending user.

6. The method of claim 5, further comprising the step of verifying that the credentials received from the sending user match the credentials in the record of the sending user in the attached database.

7. The method of claim 6, wherein the step of decreasing the credit balance of the sending user further comprises transmitting, via the communications network, a message to the mobile device of the sending user indicating that the credit balance of the sending user has been modified to reflect the deduction of the second credit amount.

8. A web server for facilitating transfer of credit over a communications network, comprising:
a database for storing a plurality of user records, wherein each user record includes a unique identifier and a credit balance;
a network interface device communicatively coupled with the communications network; and
a processor configured for:
receiving, via the communications network, credit confirmation from a payment gateway, wherein the credit confirmation includes the unique identifier for a sending user, and a first credit amount;
increasing the credit balance of the sending user in the record of the sending user to reflect the first credit amount of the credit confirmation;
receiving from a mobile device of the sending user, via the communications network, a command to transfer a second credit amount, and a unique identifier for a receiving user, wherein the command to transfer and the unique identifier are entered by the sending user into a graphical user interface in the mobile device of the sending user;
determining that the second credit amount is less than the credit balance of the sending user in the record of the sending user;
decreasing the credit balance of the sending user in the record of the sending user by the second credit amount, and increasing the credit balance of the receiving user in the record of the receiving user by the second credit amount; and
transmitting, via the communications network, a credit increase confirmation to a mobile device of the receiving user, wherein the credit increase confirmation includes the credit balance of the receiving user in the record of the receiving user.

9. The web server of claim 8, wherein each record further includes credentials for a user.

10. The web server of claim 9, wherein the credit confirmation is encrypted and wherein the credit confirmation also includes a time stamp.

11. The web server of claim 10, wherein the step of increasing the credit balance of the sending user further comprises transmitting, via the communications network, a message to the mobile device of the sending user indicating that the credit balance of the sending user has been modified to reflect the addition of the first credit amount.

12. The web server of claim 11, wherein the step of receiving from the mobile device of the sending user further includes receiving credentials from the mobile device of the sending user, via the communications network, wherein the credentials are entered by the sending user into the graphical user interface in the mobile device of the sending user.

13. The web server of claim 12, further comprising the step of verifying that the credentials received from the sending user match the credentials in the record of the sending user in the attached database.

14. The web server of claim 13, wherein the step of decreasing the credit balance of the sending user further comprises transmitting, via the communications network, a message to the mobile device of the sending user indicating that the credit balance of the sending user has been modified to reflect the deduction of the second credit amount.
